(19) United States
(12) Patent Application Publication
(10) Pub. No.: US 2017/0249005 A1
(43) Pub. Date: Aug. 31, 2017

(54) DISPLAY APPARATUS AND METHOD OF DRIVING THE SAME

(71) Applicant: Samsung Display Co., Ltd., Yongin-si (KR)

(72) Inventors: Jong-Kwang HWANG, Asan-si (KR); Il-Han LEE, Cheonan-si (KR)

(21) Appl. No.: 15/421,196

(22) Filed: Jan. 31, 2017

(30) Foreign Application Priority Data
Feb. 26, 2016 (KR) 10-2016-0022983

(51) Int. Cl. G06F 1/32; G09G 3/20

(52) U.S. Cl. CPC G06F 1/3228; G09G 3/2092; G09G 2330/022; G09G 2310/0202; G09G 2310/027; G09G 2310/0289

(57) ABSTRACT

A display apparatus includes a display panel comprising a plurality of pixels, a voltage generator configured to generate a plurality of driving voltages for driving the display panel, a memory configured to store correction data for correcting image data corresponding to the plurality of pixels, and a controller configured to shut down the voltage generator and to block a driving voltage from being applied to the memory in response to a command signal including a deep-sleep command.

This application claims priority to and the benefit of Korean Patent Application No. 10-2016-0022983 filed on Feb. 26, 2016, which is hereby incorporated by reference for all purposes as if fully set forth herein.

### BACKGROUND

1. Field

Exemplary embodiments of the inventive concept relate to a display apparatus and a method of driving the display apparatus. More particularly, example embodiments of the inventive concept relate to a display apparatus for decreasing power consumption and a method of driving the display apparatus.

2. Description of the Related Art

Recently, as a market of a smart phone extends, a high resolution display device has been provided to the mobile phone. The high resolution display device receives an image signal from a host through a display drive IC to display the image signal. When a portable display device as described above receives a still image from the host to display the still image, power consumption occurs in a memory access and an interface of the host.

In a manufacturing process of a display apparatus, the display apparatus is tested through a visual test process which tests electrical and optical operations of the display panel. In general, the visual test process includes testing for various Mura patterns and calculating correction data for removing the various Mura patterns using Mura remover algorithms. And then, the correction data which remove the various Mura patterns are stored in a memory. The memory is mounted in the display apparatus.

The display apparatus includes the display panel and a driver circuit driving the display panel. The driver circuit receives an input power source from an outside and the memory also receives the input power source at the same time. A leakage current occurs by driving the memory in a low-power mode in which the driver circuit is driven by a low power and thus power consumption may be increased.

### BRIEF SUMMARY

Exemplary embodiments of the inventive concept provide a display apparatus for decreasing power consumption.

Exemplary embodiments of the inventive concept provide a method of driving the display apparatus.

According to an exemplary embodiment of the inventive concept, there is provided a display apparatus. The display apparatus includes a display panel comprising a plurality of pixels, a voltage generator configured to generate a plurality of driving voltages for driving the display panel, a memory configured to store correction data for correcting image data corresponding to the plurality of pixels, and a controller configured to shut down the voltage generator and to block a driving voltage from being applied to the memory in response to a command signal including a deep-sleep command.

In an exemplary embodiment, the command signal may include a power-down command to block the driving voltage from being applied to the memory.

In an exemplary embodiment, the display apparatus may further include a data driver configured to provide a data line connected to a pixel with a data voltage, a scan driver configured to provide a gate line connected to the pixel with a gate signal, and a scan driving controller configured to generate a scan driving signal for driving the scan driver

In an exemplary embodiment, the display apparatus may further include a main driver circuit disposed in a peripheral area surrounding a display area in which the plurality of pixels is arranged, wherein the main driver circuit comprises the controller, the data driver, the voltage generator and the scan driving controller.

In an exemplary embodiment, the scan driver may be disposed in the peripheral area.

In an exemplary embodiment, the diving voltage may be an input power source which is commonly applied to the memory and the main driver circuit.

According to an exemplary embodiment of the inventive concept, there is provided a method of driving a display apparatus. The method includes receiving a command signal comprising a deep-sleep command corresponding to a deep-sleep mode, shutting down a voltage generator which is configured to generate a plurality of driving voltages for driving a display panel in response to the command signal comprising the deep-sleep command, and blocking a driving voltage from being applied to a memory which is configured to store correction data for correcting image data displayed on the display panel.

In an exemplary embodiment, the method may further include generating a first control signal and a second control signal based on the deep-sleep command, shutting down the voltage generator in response to the first control signal and blocking the driving voltage from being applied to the memory in response to the second control signal common voltage line may be parallel to the data line.

In an exemplary embodiment, the command signal may include a power-down command which blocks the driving voltage from being applied to the memory.

In an exemplary embodiment, the method may further include generating a first control signal based on the deep-sleep command, generating a second control signal based on the power-down command, shutting down the voltage generator in response to the first control signal, and blocking the driving voltage from being applied to the memory in response to the second control signal.

In an exemplary embodiment, the driving voltage may be an input power source which is commonly applied to the memory and a main driver circuit which includes the voltage generator.

According to an exemplary embodiment of the inventive concept, in the deep-sleep mode, the main driver circuit of the display apparatus is configured to block a plurality of driving signal for driving the display panel from being provided to the display panel and to block a driving voltage from being applied to the memory so that the memory is driven with the power-down mode. Therefore, leakage current occurring by driving of the memory in the deep-sleep mode may be eliminated and thus power consumption may be decreased.

### BRIEF DESCRIPTION OF THE DRAWINGS

The above and other features and advantages of the inventive concept will become more apparent by describing in detailed exemplary embodiments thereof with reference to the accompanying drawings, in which:

FIG. 1 is a conceptual diagram illustrating a display apparatus according to an exemplary embodiment;

FIG. 2 is a block diagram illustrating a main driver circuit according to an exemplary embodiment;

FIG. 3 is a flowchart illustrating a method of driving a display apparatus according to an exemplary embodiment; and

FIG. 4 is a flowchart illustrating a method of driving a display apparatus according to an exemplary embodiment.

### DETAILED DESCRIPTION

Hereinafter, the inventive concept will be explained in detail with reference to the accompanying drawings.

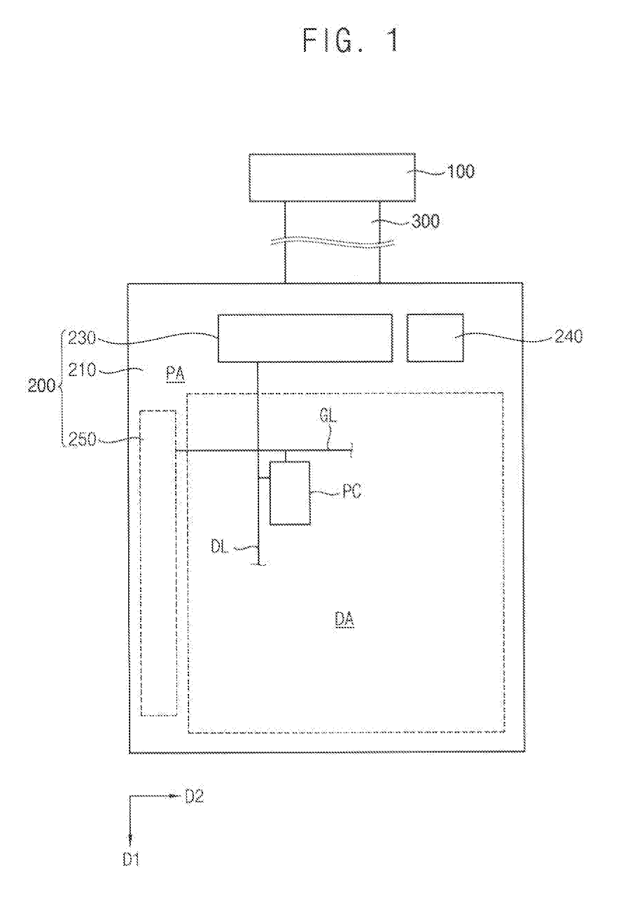

FIG. 1 is a conceptual diagram illustrating a display apparatus according to an exemplary embodiment.

Referring to FIG. 1, the display may include an external apparatus 100, for example, a graphic controller, a display apparatus 200 and a connection member 300.

The external apparatus 100 is configured to transmit an original image signal, an original control signal and a command signal, to the display apparatus 200. The original image signal may include red, green and blue grayscale data. The original control signal may include a horizontal synchronization signal, a vertical synchronization signal, and a data enable signal, etc. The command signal may include a plurality of commands for controlling a driving mode of the display apparatus. For example, the plurality of commands may include a deep-sleep command and a power-down command. The deep-sleep command may block a plurality of driving voltages from being provided to a plurality of driver circuits for driving the display panel. The power-down command may block a driving voltage for driving the memory 240 from being applied to the memory 240. For example, the driving voltage for driving the memory 240 may be an input power source received from an outside.

According to an exemplary embodiment, when a mode control signal corresponding to the deep-sleep mode is received, the external apparatus 100 is configured to generate a command signal which includes a deep-sleep command for driving the display panel 210 with a deep-sleep mode and a power-down command for driving the memory 240 with a power-down mode, and to transmit the command signal to the display apparatus 200.

Alternatively, according to an exemplary embodiment, when a mode control signal corresponding to the deep-sleep mode is received, the external apparatus 200 is configured to generate a command signal which includes a deep-sleep command for driving the display panel 210 with a deep-sleep mode, and to transmit the command signal to the display apparatus 200. In this case, the display apparatus 200 is configured to generate a first control signal corresponding to the deep-sleep mode and a second control signal corresponding to the power-down mode based on the deep-sleep command.

The display apparatus 200 may be connected to the external apparatus 100 through the connection member 300.

The display apparatus 200 may include a display panel 210, a main driver circuit 230, a memory 240 and a scan driver 250.

The display panel 210 may include a display area DA and a peripheral area PA surrounding the display area DA.

A plurality of pixels may be arranged in the display area DA in a matrix configuration. A pixel of the plurality of pixels may include a pixel circuit. The pixel circuit may include at least one transistor which is connected to at least one first signal line and at least one second signal line and a display element which is connected to the at least one transistor. A first signal line may include a data line DL which extend in a first direction D1 and is arranged in a second direction D2 crossing the first direction D1. A second signal line may include a gate line GL which extend in the second direction D2 and is arranged in the first direction D1.

The main driver circuit 230, the memory 240 and the scan driver 250 may be disposed in the peripheral area PA.

The main driver circuit 230 is configured to receive an original control signal OCS, original image data O_DATA and a command signal COMD from the external apparatus 100. The original control signal OCS may include a vertical synchronization signal, a horizontal synchronization signal and a main clock signal. The original image data O_DATA may include red, green and blue grayscale data. The command signal COMD is configured to control a driving mode of the display apparatus 200. The command signal COMD may include a deep-sleep command and a power-down command. The main driver circuit 230 is configured to generate a plurality of panel driving signals for driving the display panel 210 using the original control signal OCS. The main driver circuit 230 is configured to correct the original image data O_DATA using Mura correction data depend on grayscale data stored in the memory 240 and to generate the image data corrected the Mura C-DATA depend on the grayscale.

According to the exemplary embodiment, the main driver circuit 230 is configured to receive the deep-sleep command and the power-down command corresponding to a deep-sleep mode from the external apparatus 100. The main driver circuit 230 is configured to generate a first control signal corresponding to the deep-sleep command and a second control signal corresponding to the power-down command. Thus, the main driver circuit 230 is configured to block a plurality of driving voltages from being provided to a plurality of driver circuits based on the first control signal, so that the display panel 210 is driven with the deep-sleep mode. The main driver circuit 230 is configured to blocks a driving voltage that is the input power source, from being applied to the memory 240 based on the second control signal so that the memory 240 is driven with the power-down mode.

According to an exemplary embodiment, the main driver circuit 230 is configured to receive the deep-sleep command corresponding to the deep-sleep mode from the external apparatus 100. The main driver circuit 230 is configured to generate a first control signal and a second control signal based on the deep-sleep command. The main driver circuit 230 is configured to block the plurality of driving voltages from being provided to a plurality of driver circuits based on the first control signal so that the display panel 210 is driven with the deep-sleep mode. The main driver circuit 230 is configured to block the input power source from being applied to the memory 240 based on the second control signal so that the memory 240 is driven with the power-down mode.

The memory 240 is configured to store correction data for compensating Mura based on each of the red, green and blue grayscale data. The memory 240 may be a flash memory. Generally, the memory 240 is configured to drive while the display panel 210 displays an image. According to the exemplary embodiments, the memory 240 is driven with the power-down mode while the display panel 210 is driven with the deep-sleep mode.

According to the exemplary embodiments, when the display panel 210 is driven with the deep-sleep mode in which the image is not displayed on the display panel 210, the main driver circuit 230 is configured to block the driving voltage that is, the input power source from being applied to the memory 240 based on the second control signal. Therefore, the memory is driven with the power-down mode during the deep-sleep mode and a leakage current by the memory 240 may be eliminated. Thus, power consumption may be decreased.

The scan driver 250 is configured to receive a scan control signal SCS from the controller 232, and to sequentially output a plurality of gate signals in response to the scan control signal SCS. The scan driver 250 may be disposed in the peripheral area PA as a tape carry package (TCP) type. Alternatively, the scan driver 250 may be formed as one-chip together with the main driver circuit 210. Alternatively, the scan driver 250 may be formed via the process substantially same as that forming a plurality of transistors in the display area.

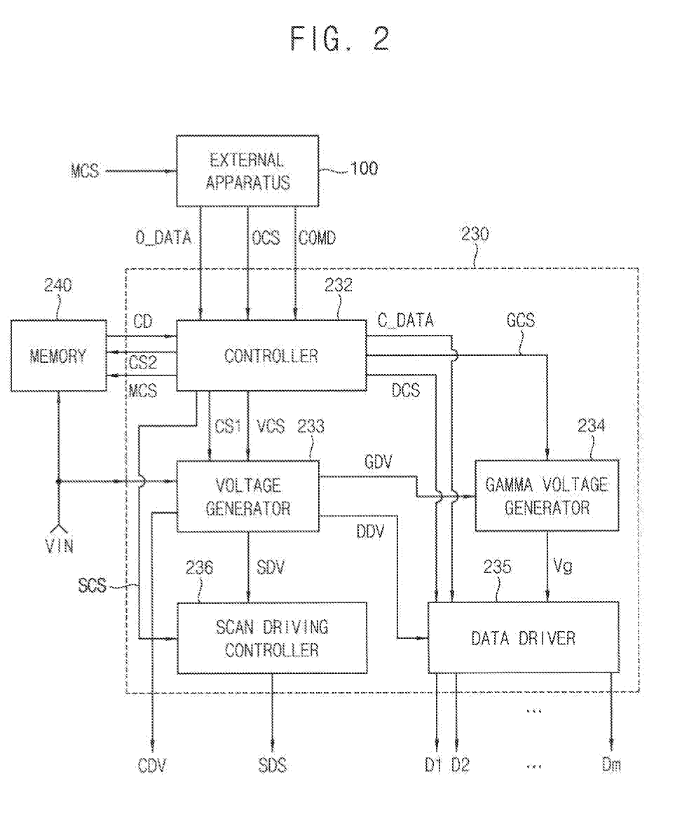

FIG. 2 is a block diagram illustrating a main driver circuit according to an exemplary embodiment.

Referring to FIGS. 1 and 2, the display apparatus 200 may include the main driver circuit 230 and the memory 240. The input power source VIN may be commonly applied to the main driver circuit 230 and the memory 240. The main driver circuit 230 may include a controller 232, a voltage generator 233, a gamma voltage generator 234, a data driver 235, and a scan driving controller 236.

The controller 232 is configured to receive an original control signal OCS which comprises a vertical synchronization signal, a horizontal synchronization signal and a main clock from the external apparatus 100. The controller 232 is configured to generate a panel control signal using the original control signal. The controller 232 is configured to transmit the panel control signal for controlling a plurality of drivers in the main driver circuit 230 to the plurality of drivers in the main driver circuit 230 through I2C (Inter Integrated Circuit) communication. For example, the panel control signal may include a voltage control signal VCS for controlling the voltage generator 233, a gamma control signal GCS for controlling the gamma voltage generator 234, a data control signal DCS for controlling the data driver 235, and a scan control signal SCS for controlling the scan driving controller 236. In addition, the panel control signal may include a memory control signal MCS for controlling the memory 240.

The controller 232 is configured to receive the original image data which comprises the red, green and blue grayscale data from the external apparatus 100, and to compensate the original image data through various compensation algorithms. In addition, the controller 232 is configured to correct the original image data using Mura correction data CD which are the red, green and blue grayscale data stored in the memory 240, and to output corrected image data C_DATA to the data driver 235.

The controller 232 is configured to receive a command signal from the external apparatus 100, and to generate at least one control signal for controlling the main driver circuit 230 based on the command signal.

According to an exemplary embodiment, when a deep-sleep command is received from the external apparatus 100, the controller 232 is configured to generate a first control signal CS1, and to block a plurality of driving voltages from being provided to the gamma voltage generator 234, the data driver 235, and the scan driving controller 236 in the main driver circuit 230 based on the first control signal CS1. The plurality of driving voltages for driving the display panel 210 may comprise a gamma driving voltage GDV for driving the gamma voltage generator 234, a data driving voltage DDV for driving the data driver 235, a scan driving voltage SDV for driving the scan driving controller 236, and a common driving voltage CDV for driving the display panel 210. Thus, the controller 232 is configured to transmit the first control signal CS1 to the voltage generator 233 through an I2C communication. The voltage generator 233 is configured to shut down the gamma voltage generator 234, the data driver 235, the scan driving controller 236, and the display panel 210 based on the first control signal CS1. Thus, the plurality of driving voltages for driving the display panel 210 may be blocked from being provided to the gamma voltage generator 234, the data driver 235, and the scan driving controller 236 in the main driver circuit 230. Therefore, the plurality of pixels in the display panel 210 is driven with the deep-sleep mode in which the image is not displayed.

In addition, when a power-down command is received from the external apparatus 100, the controller 232 is configured to generate a second control signal CS2 which blocks a driving voltage for driving the memory 240 form being applied to the memory 240. For example, the driving voltage of the memory 240 may be an input power source VIN which is commonly applied to the voltage generator 233 and the memory 240. The controller 232 is configured to transmit the second control signal CS2 to the memory 240 through an I2C communication. The memory 240 blocks an input power source VIN from being applied to the memory 240 in response to the second control signal CS2. Therefore, the memory 240 is driven with the power-down mode during the deep-sleep mode.

Alternatively, according to an exemplary embodiment, when the deep-sleep command is received from the external apparatus 100, the controller 232 is configured to generate a first control signal CS1 and a second control signal CS2. The first control signal CS1 shuts down the voltage generator 233 to block a plurality of driving voltages from being provided to a plurality of drivers in the main driver circuit 230. The second control signal CS2 blocks an input power source VIN of the memory 240 from being applied to the memory 240. Therefore, the plurality of pixels in the display panel 210 is driven with the deep-sleep mode and the memory 240 is driven with the power-down mode during the deep-sleep mode.

The voltage generator 233 is configured to generate a plurality of driving voltages using the input power source VIN received from an outside. The input power source VIN may be commonly applied to the memory 240 and the voltage generator 233. The plurality of driving voltages may comprise a gamma driving voltage GDV for driving the gamma voltage generator 234, a data driving voltage DDV for driving the data driver 235, a scan driving voltage SDV for driving the scan driving controller 236, and a common driving voltage CDV for driving the display panel 210.

The gamma driving voltage GDV may comprise a white voltage and a black voltage. The data driving voltage DDV may comprise an analog power source AVDD which is used to generate a data voltage and a digital power source DVDD which is used to drive a logical circuit. The scan driving voltage SDV may comprise a gate high voltage and a gate low voltage which are used to generate a scan signal. The common driving voltage CDV may comprise a common voltage VCOM when a pixel circuit includes a liquid crystal capacitor. Alternatively, the common driving voltage CDV may comprise a common high voltage ELVDD and a common low voltage ELVSS when a pixel circuit include an organic light emitting diode.

The gamma voltage generator 234 is configured to generate a plurality of reference gamma voltages Vg using the white and black voltages.

The data driver 235 is configured to convert the corrected image data C-DATA received from the controller 232 to data voltages D1, D2, . . . , Dm using the reference gamma voltages Vg and to output the data voltages D1, D2, . . . , Dm to data lines of the display panel 210.

The scan driving controller 236 is configured to generate a scan driving signal SDS which comprises a plurality of clock signals and at least one scan start signal, and to provide the scan driver 250 with scan driving signal SDS.

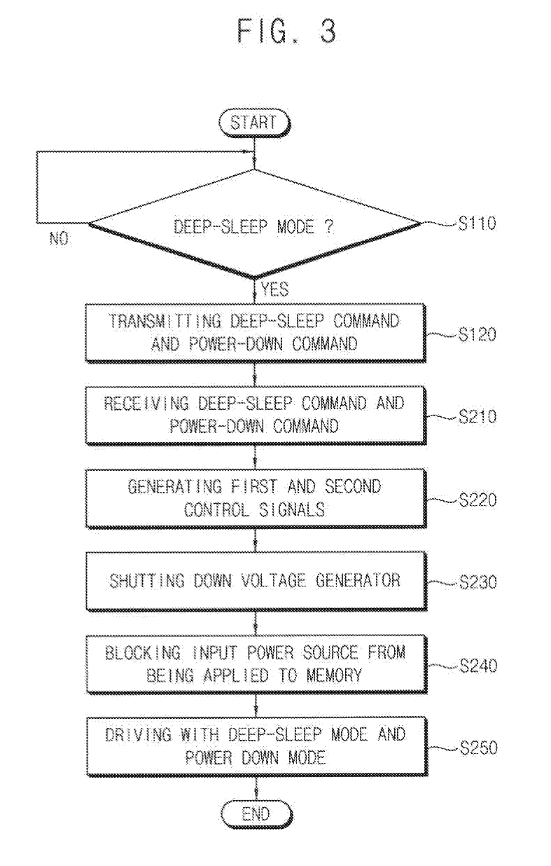

FIG. 3 is a flowchart illustrating a method of driving a display apparatus according to an exemplary embodiment.

Referring to FIGS. 2 and 3, the external apparatus 100 is configured to receive a mode control signal corresponding to a deep-sleep mode from a user (Step S110). The external apparatus 100 is configured to generate a command signal COMD which comprises a deep-sleep command and a power-down command. The external apparatus 100 is configured to transmit the command signal COMD which comprises the deep-sleep command and the power-down command, to a main driver circuit 230 of the display apparatus 200 (Step S120).

The controller 232 in the main driver circuit 230 is configured to receive the command signal COMD which comprises the deep-sleep command and the power-down command (Step S210).

The controller 232 is configured to generate a first control signal CS1 which blocks a plurality of driving voltages for driving the display panel 210 from being provided to a plurality of drivers in the main driver circuit 230 based on the deep-sleep command and a second control signal CS2 which blocks a driving voltage of the memory 240 from being applied to the memory 240 based on the power-down command (Step S220).

The plurality of driving voltages for driving the display panel 210 may comprise a gamma driving voltage GDV for driving the gamma voltage generator 234, a data driving voltage DDV for driving the data driver 235, a scan driving voltage SDV for driving the scan driving controller 236, and a common driving voltage CDV for driving the display panel 210.

Thus, the controller 232 is configured to transmit the first control signal CS1 to the voltage generator 233 through an I2C communication. The voltage generator 233 is configured to shut down the gamma voltage generator 234, the data driver 235, the scan driving controller 236, and the display panel 210 based on the first control signal CS1 (Step S230). Thus, the plurality of driving voltages for driving the display panel 210 may be blocked from being provided to the gamma voltage generator 234, the data driver 235, and the scan driving controller 236 in the main driver circuit 230.

The controller 232 is configured to transmit the second control signal CS2 to the memory 240 through the I2C communication. The memory 240 blocks an input power source VIN from being applied to the memory 240 in response to the second control signal CS2 (Step S240).

As described above, the display panel 210 is driven with the deep-sleep mode and the memory is driven with the power down mode (Step S250).

The step 230 and the step 240 may be carried out at the same time.

According to the exemplary embodiment, the display panel 210 may be driven with the deep-sleep mode and besides, the memory 240 may be driven with the power-down mode. Thus, in the deep-sleep mode, leakage current occurring by the memory 240 may be eliminated and power consumption may be decreased.

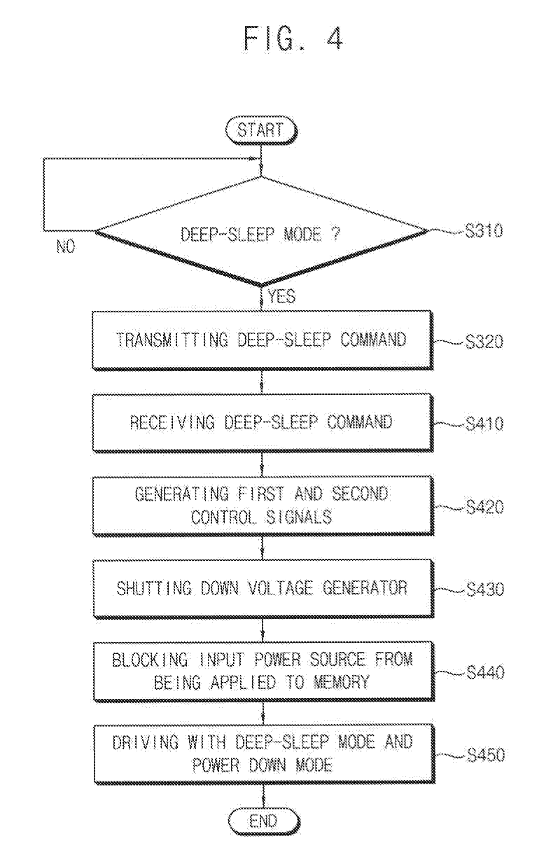

FIG. 4 is a flowchart illustrating a method of driving a display apparatus according to an exemplary embodiment.

Referring to FIGS. 2 and 4, the external apparatus 100 is configured to receive a mode control signal corresponding to a deep-sleep mode from a user (Step S310). The external apparatus 100 is configured to generate a command signal which comprises a deep-sleep command. The external apparatus 100 is configured to transmit the command signal COMD which comprises the deep-sleep command to a main driver circuit 230 of the display apparatus 200 (Step S320).

The controller 232 in the main driver circuit 230 is configured to receive the command signal COMD which comprises the deep-sleep command (Step S410).

The controller 232 is configured to generate a first control signal CS1 and a second control signal CS2 based on the deep-sleep command. The first control signal CS1 blocks a plurality of driving voltages from being provided to a plurality of drivers in the main driver circuit 230. The second control signal CS2 blocks a driving voltage of the memory 240 from being applied to the memory 240 (Step S420).

The plurality of driving voltages for driving the display panel 210 may comprise a gamma driving voltage GDV for driving the gamma voltage generator 234, a data driving voltage DDV for driving the data driver 235, a scan driving voltage SDV for driving the scan driving controller 236, and a common driving voltage CDV for driving the display panel 210.

Thus, the controller 232 is configured to transmit the first control signal CS1 to the voltage generator 233 through an I2C communication. The voltage generator 233 is configured to shut down the gamma voltage generator 234, the data driver 235, the scan driving controller 236, and the display panel 210 based on the first control signal CS1. Thus, the plurality of driving voltages may be blocked from being provided to the gamma voltage generator 234, the data driver 235, and the scan driving controller 236 in the main driver circuit 230 (Step S430).

The controller 232 is configured to transmit the second control signal CS2 to the memory 240 through the I2C communication. The memory 240 blocks an input power source VIN from being applied to the memory 240 in response to the second control signal CS2 (Step S440).

The step 430 and the step 440 may be carried out at the same time.

As described above, the display panel 210 is driven with the deep-sleep mode and the memory is driven with the power down mode (Step S450).

According to the exemplary embodiment, the display panel 210 may be driven with the deep-sleep mode and the memory 240 may be driven with the power-down mode. Thus, in the deep-sleep mode, leakage current occurring by the memory 240 may be eliminated and power consumption may be decreased.

According to the exemplary embodiments, in the deep-sleep mode, the main driver circuit of the display apparatus is configured to not only block a plurality of driving signal for driving the display panel from being provided to the display panel but also block a driving voltage from being applied to the memory so that the memory is driven with the power-down mode. Therefore, leakage current occurring by driving of the memory may be eliminated and thus power consumption may be decreased.

The foregoing is illustrative of the inventive concept and is not to be construed as limiting thereof. Although a few exemplary embodiments of the inventive concept have been described, those skilled in the art will readily appreciate that many modifications are possible in the exemplary embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific exemplary embodiments disclosed, and that modifications to the disclosed exemplary embodiments, as well as other exemplary embodiments, are intended to be included within the scope of the appended claims. The inventive concept is defined by the following claims, with equivalents of the claims to be included therein.

What is claimed is:

1. A display apparatus comprising:
a display panel comprising a plurality of pixels;
a voltage generator configured to generate a plurality of driving voltages for driving the display panel;
a memory configured to store correction data for correcting image data corresponding to the plurality of pixels; and
a controller configured to shut down the voltage generator and to block a driving voltage from being applied to the memory in response to a command signal including a deep-sleep command.

2. The display apparatus of claim 1, wherein the command signal comprises a power-down command to block the driving voltage from being applied to the memory.

3. The display apparatus of claim 1, further comprising:
a data driver configured to provide a data line connected to a pixel with a data voltage;
a scan driver configured to provide a gate line connected to the pixel with a gate signal; and
a scan driving controller configured to generate a scan driving signal for driving the scan driver.

4. The display apparatus of claim 3, further comprising:
a main driver circuit disposed in a peripheral area surrounding a display area in which the plurality of pixels is arranged,
wherein the main driver circuit comprises the controller, the data driver, the voltage generator and the scan driving controller.

5. The display apparatus of claim 4, wherein the scan driver is disposed in the peripheral area.

6. The display apparatus of claim 4, wherein the diving voltage is an input power source which is commonly applied to the memory and the main driver circuit.

7. A method of driving a display apparatus, the method comprising:
receiving a command signal comprising a deep-sleep command corresponding to a deep-sleep mode;
shutting down a voltage generator which is configured to generate a plurality of driving voltages for driving a display panel in response to the command signal comprising the deep-sleep command; and
blocking a driving voltage from being applied to a memory which is configured to store correction data for correcting image data displayed on the display panel.

8. The method of claim 7, further comprising:
generating a first control signal and a second control signal based on the deep-sleep command;
shutting down the voltage generator in response to the first control signal; and
blocking the driving voltage from being applied to the memory in response to the second control signal.

9. The method of claim 7, wherein the command signal comprises a power-down command which blocks the driving voltage from being applied to the memory.

10. The method of claim 9, further comprising:
generating a first control signal based on the deep-sleep command;
generating a second control signal based on the power-down command;
shutting down the voltage generator in response to the first control signal; and
blocking the driving voltage from being applied to the memory in response to the second control signal.

11. The method of claim 7, wherein the driving voltage is an input power source which is commonly applied to the memory and a main driver circuit which includes the voltage generator.
